(19) United States
(12) Patent Application Publication
(10) Pub. No.: US 2020/0062232 A1
(43) Pub. Date: Feb. 27, 2020

(54) DRIVE UNIT FOR AN ACTUATOR, AND ACTUATOR INCLUDING A DRIVE UNIT AND A TRANSMISSION UNIT

(71) Applicant: Robert Bosch GmbH, Stuttgart (DE)

(72) Inventors: Andre Bollwerk, Steinheim An Der Murr (DE); Daniel Weissinger, Korntal-Muenchingen (DE); Ignaz Hatt, Buchenberg (DE); Willi Nagel, Remseck/Hochdorf (DE)

(21) Appl. No.: 16/493,014

(22) PCT Filed: Jan. 25, 2018
(86) PCT No.: PCT/EP2018/051810

§ 371 Date: Sep. 11, 2019

(30) Foreign Application Priority Data
Mar. 13, 2017 (DE) 10 2017 204 114.5

(51) Int. Cl. B60T 13/74; F16H 1/06

(52) U.S. Cl. CPC B60T 13/746; F16H 57/021; F16H 1/06

(57) ABSTRACT

A drive unit is described for driving a transmission unit of an actuator, as well as an actuator that includes a drive unit and a transmission unit. The drive unit includes an alignment element, which is engageable with a mating element of the transmission unit to be driven. The mating element is part of a transmission pin of the transmission unit.

### BACKGROUND INFORMATION

The unexamined patent application DE 102012222949 A1 describes a transmission device including a worm shaft, which may be set in rotation by an electric motor, as well as a first worm gear connected to a first pinion and a second worm gear connected to a second pinion, which contact the worm shaft in such a way that the first worm gear and the first pinion are rotatable about a shared first rotation axis and the second worm gear and the second pinion are rotatable about a shared second rotation axis. The transmission device also has an adjustable piston, which is adjustable along an adjustment axis with the aid of the first pinion rotated about the first rotation axis and with the aid of the second pinion rotated about the second rotation axis. The invention also relates to an electromotive brake booster.

### SUMMARY

The drive unit according to the present invention for driving a transmission unit of an actuator includes an alignment element, which is engageable with a mating element of the transmission unit to be driven. The mating element is part of a transmission pin of the transmission unit. This has the advantage that a mechanical interaction exists between the transmission pin and the drive element, which is suitable for stabilizing the transmission pin.

If the transmission pin were mounted on both sides in a thin transmission housing, the bearing forces transferred to the transmission housing may be too great and may result in the transmission housing being elastically deformed under load. This could have the disadvantage that the transmission pin tilts under load. A tooth engagement of a gear wheel present in the transmission with a drive gear wheel may likewise deviate increasingly from the setpoint state. This may result in greater noise generation and in greater tooth stress.

The housing of the drive unit may be more stably designed than the housing of the transmission unit, as a result of which the housing of the drive unit is better suited for supporting the transmission pin.

The housing of the drive unit is able to withstand stronger forces. Thus, a tilting of the transmission pin may be effectively prevented, which improves the functionality of the transmission unit.

The drive unit in this case may be an electric motor, in particular, an electric motor with a control unit attached, for example, a so-called power pack. The transmission unit may be part of an actuator, which is a brake booster that is to be driven with the drive unit. Alignment element and mating element may be present as a plug/socket or socket/plug.

An embodiment of the drive unit includes a drive axle connected to a drive element. The alignment element as well as the drive axle are aligned in parallel in their respective longitudinal direction and offset relative to one another, the alignment in the longitudinal direction of the drive axle and of the alignment element corresponding, in particular, to an assembly direction of the drive unit with respect to the transmission unit. This has the advantage that during an assembly, the unit alignment element and mating element may be easily engaged. With the predefined offset of alignment element and drive axle, it is possible to also easily obtain a space to be obtained between the drive axle and the transmission pin during an assembly, which ensures a better functioning of the drive and the transmission.

In one embodiment of the drive unit, the alignment element is part of a housing of the drive unit. As a result, forces of the transmission pin may be readily withstood. A simple manufacture of the drive unit with the alignment element is equally possible, for example, in one piece as a pressed part or as a stamped part or as a casting.

In an embodiment of the drive unit, the alignment element is directly or indirectly attached to a housing of the drive unit. In contrast to an alignment element as part of the housing, the alignment element in this case is present as a separate component, which is directly or indirectly connected to the housing of the drive unit. Different techniques for connecting are possible, for example, directly adhered, screwed on, welded on or also indirectly connected via a support, in particular, a motor flange. This ensures a greater modularity when selecting or designing the alignment element if it is not directly part of the housing.

The actuator according to the present invention includes such a drive unit, as well as a transmission unit. The transmission unit includes the described mating element, which may be engaged with the alignment element of the drive unit. The drive unit is mechanically connected to the transmission unit in such a way that the mating element of the transmission unit is engaged with the alignment element of the drive unit. The mating element in this case is part of a transmission pin of the transmission unit. The actuator, i.e., for example, the brake booster including the drive unit thus installed, has the advantage that an optimal alignment of the transmission pin of the transmission unit is achieved by supporting the transmission pin on the drive unit. It is also advantageous that a degree of freedom is established for a correct alignment of the drive unit relative to the transmission unit by the engagement of the alignment element and the mating element. This allows for a simpler assembly.

In an embodiment of the actuator, the alignment element and the mating element are complementary to one another.

In another embodiment, it is provided that the alignment element and the mating element are complementary in such a way that the alignment element is plug-like and the mating element is socket-like. In this case, the alignment element is accommodated at least partly in the mating element. Alternatively, the alignment element may also be provided as socket-like and the mating element as plug-like, the mating element then being accommodated in the alignment element. The alternatives for providing complementary alignment and mating elements facilitate the engagement of the elements and the simple assembly of the drive unit with the transmission unit.

In an advantageous embodiment, a space is established by the parallel offset of the alignment element of the drive unit relative to the drive axle of the drive unit. As a result of the established space and as a result of the engagement of the alignment element with the mating element of the transmission pin, it is possible to establish a separation between a drive element and a transmission element. The transmission element in this case is situated on the transmission pin and is drivable with the aid of the drive element. The transmission element may be a transmission gear wheel; the drive element may be a motor pinion of the drive unit. As previously stated, a space established in such a way improves the functionality of the interaction between the drive and the transmission.

In an embodiment of the actuator, an area between the drive unit and the transmission unit, in which the mating element is engaged with the alignment element, is sealed off in a media-tight manner with the aid of a sealing element. This prevents water or dirt from being able to enter into the interior of the transmission.

It is further advantageous that the sealing element is situated around the mating element. This allows for a space-saving installation of a seal.

It may be further advantageous that the sealing element is also situated around the alignment element when the alignment element engages with the mating element. A surrounding seal capable of surrounding both parts may render another additional seal expendable.

In an embodiment, the sealing element may be situated between a housing wall of the drive unit and a housing wall of the transmission unit. This arrangement enables a simple fixing of the seal, since the drive unit and the transmission unit, during assembly, are fixed with respect to one another anyway.

In an embodiment of the present invention, the mating element, as well as the sealing element, is covered by a cap. It is therefore sufficient to provide one single seal and no additional separate seal. A covering of the mating element is accompanied by a corresponding covering of the corresponding alignment element. A covering may be present independently thereof, which element from the alignment element and mating element is provided as a pin and which element is provided as a cavity or hole. The cap is then to be adapted according to the alignment.

The cap advantageously has a step-like design and includes an annular surface and a circular surface. The circular surface covers the mating element and the annular surface covers at least partly the sealing element. Thus, the cap is optimally adapted to the existing geometry of the mating element and the alignment element, in order to ensure the seal with only one sealing element.

In another embodiment, the sealing element is situated between a housing wall of the drive unit or a motor flange of the drive unit on the one hand, as well as a housing wall of the transmission unit on the other hand. This allows for a sealing of the respectively present opposing components of the drive unit and the transmission unit.

### BRIEF DESCRIPTION OF THE DRAWINGS

FIG. 1 shows a part of an actuator including a transmission unit and a drive unit.

FIG. 2 shows a drive unit.

FIG. 3 shows a connection point between a drive unit and a transmission unit.

FIG. 4 shows a connection point between a drive unit and a transmission unit.

FIG. 5, FIG. 6 and FIG. 7 show approaches for sealing a connection point.

### DETAILED DESCRIPTION

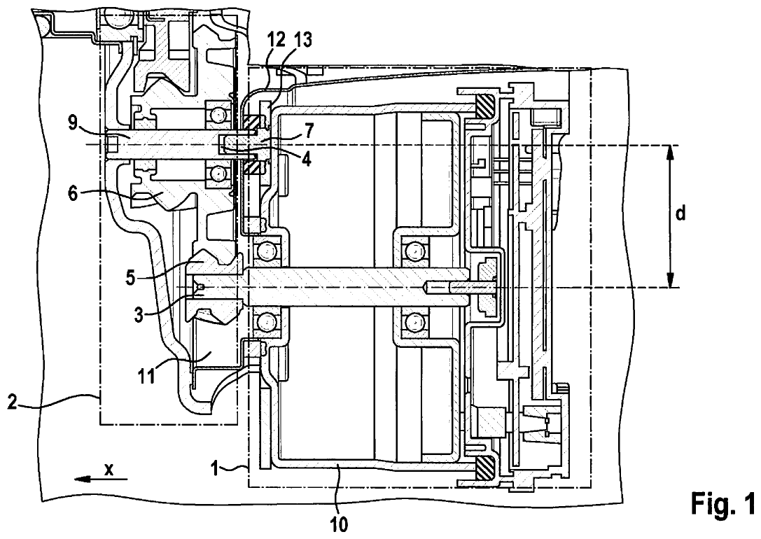

FIG. 1 shows a detail of an actuator, which includes at least one drive unit 1 as well as a transmission unit 2. Such an actuator may, for example, be a brake booster, which generates hydraulic brake pressure in a hydraulic braking system by displacing motor-driven pressure pistons and, in the process, generating a braking action either automatically, i.e., driver-independent, or also in the form of a force assist of a driver during pressure build-up. A use in other actuators that are not brake boosters is also possible.

Drive unit 1 may be an electric motor 1 that includes a drive axle 3. Drive axle 3 is rotatably mounted on a motor housing 10 and is mechanically connected to a motor pinion 5. Motor pinion 5 is attached or is formed, in particular, formed in one piece, on one end of drive axle 3.

Transmission unit 2 includes a transmission gear wheel 6 to be driven. Transmission gear wheel 6 is mounted on a transmission pin 9. Transmission gear wheel 6 is mounted on transmission pin 9 in such a way that transmission gear wheel 6 is rotatable about transmission pin 9. Transmission unit 2 is able to produce a movement in an actuator, for example, in a brake booster. A spindle drive of a brake booster may, for example, be driven as an actuator via transmission gear wheel 6.

Transmission gear wheel 6 of transmission unit 2 is driven by drive unit 1. For this purpose, the motor of drive unit 1 sets motor pinion 5 in rotation via drive axle 3. Motor pinion 5 engages with transmission gear wheel 6. Motor pinion 5 may be engaged with transmission gear wheel 6 via corresponding toothings of motor pinion 5 and transmission gear wheel 6.

In order for motor pinion 5 to mechanically contact transmission gear wheel 6, motor pinion 5 is introduced into an interior space 11 of transmission unit 2. This may take place by inserting motor pinion 5 into interior space 11 through an opening of a housing part 12 of transmission unit 2. Motor pinion 5 in this case may already be mounted on, formed on or connected to drive axle 3.

Motor pinion 5 may be introduced into interior space 11 of the transmission unit by installing drive unit 1 together with transmission unit 2. For this purpose, drive unit 1, with motor pinion 5, may be moved toward transmission unit 2, for example, in assembly direction x. Transmission unit 2 may alternatively also be moved toward drive unit 1.

When motor pinion 5 interacts with transmission gear wheel 6, motor pinion 5 and transmission gear wheel 6 should be situated precisely relative to one another so that a sufficient mechanical engagement takes place between the driving component (motor pinion 5) and the driven component (transmission gear wheel 6). Forces are also transmitted during an interaction of motor pinion 5 and of the transmission gear wheel, which may result in a deviation from a previous exact arrangement of the components as a result of their load.

Drive unit 1 includes an alignment element 7, which ensures the exact arrangement of motor pinion 5 relative to transmission gear wheel 6. Transmission unit 2 also includes a mating element 4, which also ensures the exact arrangement of the motor pinion relative to transmission gear wheel 6.

An alignment element 7 may be a pin 7 or also a journal 7. Such a pin 7 or journal 7 may be formed on housing 10 of drive unit 1. Formed may be understood to mean, on the one hand, that alignment element 7 and housing 10 are one piece. Alternatively, alignment element 7 may be formed on housing 10 by being fastened thereto, for example, bonded, welded or screwed. Other fastening methods are also conceivable

It is equally possible for alignment element 7 to be formed as a recess 7 or as a cavity 7 or as a hole 7 in or on housing 10 of drive unit 1. In this embodiment of alignment element 7 as well, alignment element 7 may be attached to the housing, or also formed in the housing. Fastening techniques also include known fastening methods, in particular, the fastening techniques cited as pin or journal in the embodiment.

Mating element 4 of transmission unit 2 is formed complementary to alignment unit 7. Complementary is understood to mean that mating element 4 and alignment element 7 in their geometric dimensioning are provided in such a way that they are able to engage one another. In the case of a pin as alignment element 7, corresponding mating element 4, for example, is provided as a cavity or hole. The diameter and depth of cavity 4 or hole 4 are designed in such a way that pin 7 may be at least partly accommodated in cavity 4. Furthermore, pin 7 may be force-fittingly accommodated in cavity 4. Once introduced—if necessary using a press-in force, pin 7 may thus be retained in cavity 4. A transfer of forces from one component to another is also possible as a result of a force-fit.

For the alternative case of one specific embodiment, in which an alignment element 7 is provided as a cavity on drive unit 1, complementary mating element 4 is provided as pin 4.

As previously described, transmission unit 2 includes a transmission pin 9, which is mounted on housing 12 of transmission unit 2. One end of transmission pin 9 in this case protrudes through an opening in transmission housing 12 in the direction of drive unit 1. Mating element 4 is formed at the end of transmission pin 9, which protrudes through the opening of transmission housing 12.

Mating element 4 of transmission unit 2 is formed on transmission unit 2 at a point opposite alignment element 7 when transmission unit 2 and drive unit 1 are assembled. In other words, the positionings of alignment element 7 on drive unit 1 and of mating element 4 on transmission unit 2 match one another in such a way that mating element 4 and alignment element 7 are able to engage during a correspondingly oriented assembly.

As described above, motor pinion 5 extends into interior space 11 of transmission unit 2 through an opening in transmission housing 2. As a result of the opening in transmission housing 2 for motor pinion 5 and as a result of the respective positioning of alignment element 7 on drive unit 1 and of mating element 4 on transmission unit 2, an alignment is defined, in which drive unit 1 is to be assembled with transmission unit 2. Only in such a corresponding alignment of transmission unit 2 relative to drive unit 1 is a precisely fitting assembly of the parts able to take place.

A motor flange 13 may also be provided between drive unit 1 and transmission unit 2, which facilitates an attachment and/or a connection of the two units. Mentioned alignment element 7 may also be fastened to or also be formed in one piece with motor flange 13. It is equally possible for alignment element 7 to be indirectly formed on drive unit 1 in the shape of a recess or cavity, for example, via motor flange 13. An indirect formation on drive unit 1 via motor flange 13 may be present in the form of a bore/of a hole in motor flange 13, motor flange 13 being fastened to drive unit 1.

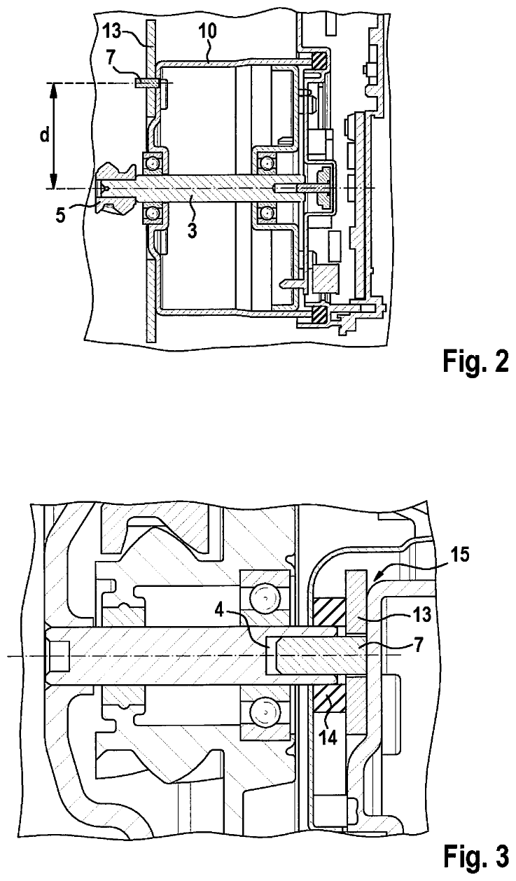

FIG. 2 shows drive unit 1 in the uninstalled state, i.e., separate from transmission unit 2. Highlighted once again in FIG. 2 are drive axle 3, motor pinion 5, space d between pin 7 and drive axle 3. This space d also defines the parallel offset at which pin 7 is situated relative to drive axle 3. In the assembled state of drive unit 1 on transmission unit 2, this space also corresponds to the relative parallel offset of drive axle 3 relative to transmission pin 9. The specific embodiment shown in FIG. 2 includes alignment element 7 as a pin. The associated transmission unit (not shown) must then include a cavity 4 as mating element 4 in transmission pin 9.

In the example of a drive unit 1 shown here, alignment element 7 is not formed on, but is indirectly fastened to, housing 10 of the drive unit. Pin 7 is fastened via motor flange 13, which is attached to housing 10 of the drive unit. Thus, pin 7 is formed on drive unit 1 by being indirectly fastened thereto. Pin 7 may be pressed into motor flange 13. Pin 7 may also be pressed in and crimped. The connection between pin 7 and motor flange 13 is a rigid connection. The connection between pin 7 and motor flange 13 is media-tight, i.e., formed tight relative to air and/or water.

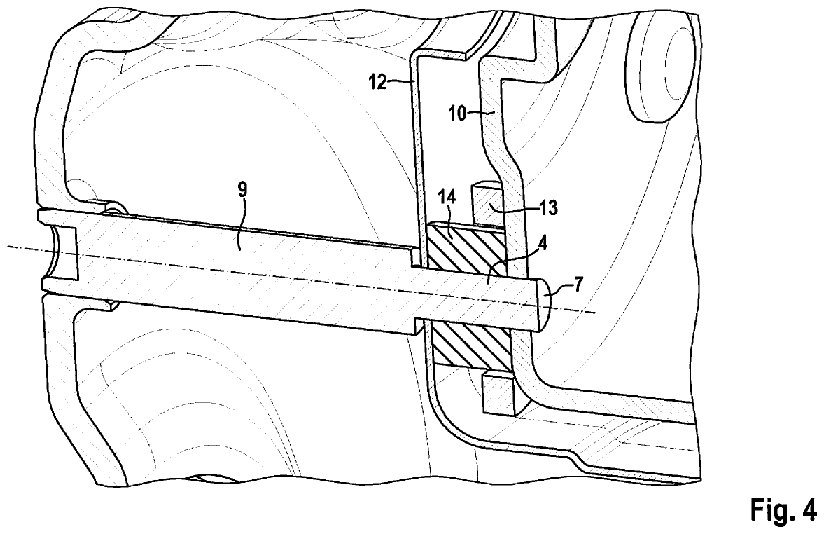

FIG. 3 shows the engagement between an alignment element 7 in the form of a pin 7 with a mating element 4 in the form of a cavity 4. Pin 7 in this embodiment is fastened, in particular, pressed and crimped in motor flange 13.

It may be necessary to prevent water from entering into the actuator. It is apparent in FIG. 3 that water could enter between drive unit 1 and transmission unit 2 at point 15. Water penetrating there may enter into transmission unit 2, in particular, in the area of the opening in housing wall 12 of transmission unit 2, which accommodates transmission pin 9. A seal 14 is attached in the area of the opening of transmission wall 12 for the purpose of sealing. In the exemplary embodiment depicted in FIG. 3, seal 14 is attached around one end of transmission pin 9, which also includes mating element 4. Seal 14 may be a sealing ring, for example. Sealing ring 14 is situated around transmission pin 9 and also includes in this case in the installed state of drive unit 1 with transmission unit 2 alignment element 7, i.e., the pin in this case. Sealing ring 14 is situated in assembly direction x (see FIG. 1) between housing wall 10 of drive unit 1 as well as housing wall 12 of transmission unit 2. If, as shown in this example, pin 7 and housing 10 of the drive unit are not one piece, but the pin is fastened to drive unit 1 with the aid of a motor flange 13, then sealing ring 14 is situated between drive unit 1 and transmission unit 2, but is at least partly in contact with motor flange 13 and housing 12 of transmission unit 2. A direct contact to housing 10 of drive unit 1 is not present in this specific embodiment.

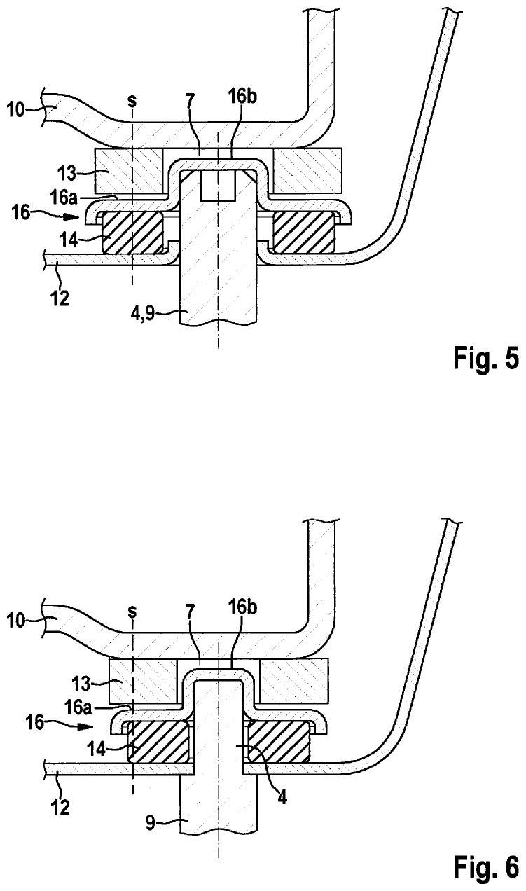

FIG. 4 shows an alternative embodiment of a seal between drive unit 1 and transmission unit 2. In this embodiment, alignment element 7 is a cavity or recess 7, in which transmission pin 9 with a tapered section 4 is supported at its end. In this embodiment, seal 14 is also situated around transmission pin 9. Seal 14 includes a part of tapered section 4 of the transmission pin. Tapered section 4 of transmission pin 9 protrudes through the opening of housing wall 12 of transmission unit 2. The axial sealing ring is situated directly, in particular, compressed in the assembled state, between housing wall 10 of drive unit 1 and housing wall 12 of transmission unit 2. Axial sealing ring 14 in this specific embodiment is encompassed along its circumference at least partly by motor flange 13.

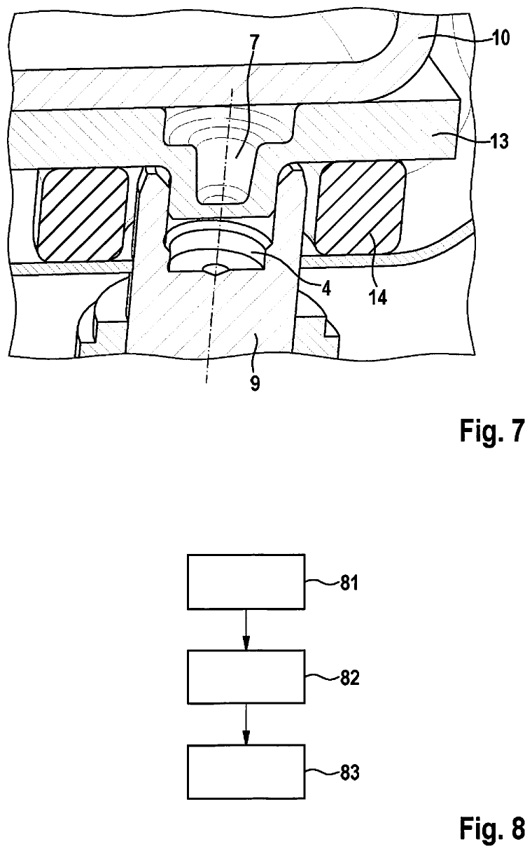

FIG. 5 shows an embodiment of FIG. 4, in which mating element 4 of transmission pin 9 corresponds to the end of transmission pin 9 that protrudes through wall 12 of the housing of transmission unit 2. Alignment element 7 in this case is a recess/cavity 7, which is formed on drive unit 1. The cavity in this case is formed in such a way that the cavity is a recess in motor flange 13, which is permanently connected to drive unit 1. The transmission pin then engages with motor flange 13 of drive unit 1 and is supported there.

The specific embodiment of FIG. 6 is based on the same principle, here however, a tapered part of transmission pin 9 engages with a corresponding cavity 7 in motor flange 13 through the opening of housing wall 12 of transmission unit 2. The design of the opening of transmission housing 12 and of cavity 7 in this case is to be adapted to tapered section 4 of transmission pin 9, in particular, to the length and to the diameter of tapered section 4.

Common to both specific embodiments of FIGS. 5 and 6 is that when supporting end section 4 (or tapered section 4 in FIG. 6) of transmission pin 9, a cap, which covers end section 4, is used as mating element 4 in motor flange 13, which is attached to drive unit 1. End section 4 (or tapered section 4 in FIG. 6) covered by cap 16 engages with cavity 7 of the motor flange and is supported there. The cap in this case is shaped like a hat with a step. An annular surface 16a covers sealing ring 14. A circular surface 16b of cap 16 covers transmission pin 9. The cap may be made from sheet metal, other materials also being conceivable.

Sealing ring 14 in both specific embodiments of FIGS. 5 and 6 is pressed in only between lateral extensions 16a of cap 16 and of housing wall 12 of transmission unit 2. In this case, a stacking in the installed state of motor housing 10, motor flange 13, lateral extensions 16a of cap 16, seal 14 as well as transmission housing wall 12 takes place, if a cut is made in assembly direction x, which also corresponds to the longitudinal direction of transmission pin 9, but somewhat beyond the center of transmission pin 9. This is clearly apparent in FIGS. 5 and 6 and is plotted as section line s.

With regard to cap 16, it may be said that in the case of the embodiment of mating element 4 as a cavity, socket or hole 4 and of an embodiment of alignment element 7 as pin 7 or plug 7, a covering may also be achieved with the aid of a cap 16. In this case the bulge of the cap would be provided inversely and would protrude into mating element 4. The diameters of the components involved would have to be adapted accordingly, since mating element 4 would then have to also accommodate the cap.

FIG. 7 shows another embodiment of a seal, here pin 7, which engages with mating element 4, being formed directly on motor flange 13.

Pin 7 in this case is in one piece with, for example, formed on motor flange 13. Motor flange 13, in turn, is permanently connected to housing 10 of drive unit 1, so that pin 7 is formed on drive unit 1 via motor flange 13. The formation in this case is not direct, but indirect via motor flange 13.

Seal 14, in turn, is an axial seal, which surrounds end section 4 of transmission pin 9, i.e. mating element 4 along the circumference thereof and is installed, in particular, compressed between drive unit 1 and transmission unit 2. Because mating element 4 and pin 7 are in engagement, the sealing ring also partly encompasses pin 7, which is situated inside mating element 4. More precisely, sealing ring 14 in this case is in direct contact with motor flange 13 and housing 12 of transmission unit 2.

A sequence results radially from the outside inwardly to the center of the axle, beginning with sealing ring 14, followed by an outer wall of mating element 4 of transmission pin 9 and by pin 7.

A sequence housing wall 12 of transmission unit 2, sealing ring 14, motor flange 13 and housing 10 of drive unit 1 results along transmission pin 9 away from the axle center, in an analogous section s as in FIGS. 5 and 6.

A method for manufacturing an actuator is schematically shown in FIG. 8.

In a first step 81, drive unit 1 and the transmission unit are aligned relative to one another. In the process, the alignment takes place in such a way that when joining the two units, drive axle 3 with motor pinion 5 may be guided through the opening in housing wall 12 of transmission unit 2. The alignment also takes place under the condition that alignment element 7 and mating element 4 are positioned opposite one another and may be brought into engagement with one another when joining drive unit 1 and transmission unit 2.

In a subsequent step 82, drive unit 1 and the transmission unit are guided toward one another, so that motor pinion 5 is introduced into interior space 11 of transmission unit 2, and alignment element 7 is also brought into engagement with mating element 4. In this step of guiding drive unit and transmission unit 1, 2 toward one another, motor pinion 5 is positioned in interior space 11 of transmission unit 2 exactly in relation to transmission gear wheel 6. The positioning takes place in such a way that a force transfer may be achieved in a known manner when motor pinion 5 rotates. The guiding toward one another takes place in assembly direction x shown in FIG. 1.

In a step 83, drive unit 1 and transmission unit 2 are then fixed to one another. A fixing may take place, for example, by screwing those two units together. Additional connection techniques are possible.

Sealing ring 14 is situated at an appropriate point prior to the guiding toward one another depending on the specific embodiment of mating element 4 and alignment element 7. Cap 16—if present in the specific embodiment—is positioned accordingly before drive unit 1 and transmission unit 2 are guided toward one another.

1.-15. (canceled)

16. A drive unit for driving a transmission unit of an actuator, comprising:
an alignment element that is engageable with a mating element of the transmission unit to be driven, wherein the mating element is part of a transmission pin of the transmission unit.

17. The drive unit as recited in claim 16, further comprising:
a drive element; and
a drive axle connected to the drive element, wherein:
the alignment element and the drive axle are aligned in parallel in respective longitudinal directions of the alignment element and the drive axle, and
the alignment element and the drive axle are offset relative to one another, and
an alignment in the longitudinal direction of the drive axle and in the longitudinal direction of the alignment element corresponds to an assembly direction of the drive unit with respect to the transmission unit.

18. The drive unit as recited in claim 16, wherein the alignment element is part of a housing of the drive unit.

19. The drive unit as recited in claim 16, wherein the alignment element is one of directly attached and indirectly attached to a housing of the drive unit.

20. An actuator, comprising:
a transmission unit; and
a drive unit for driving the transmission unit of an actuator, wherein:
the drive unit includes an alignment element engaged with a mating element of the transmission unit to be driven, and
the mating element is part of a transmission pin of the transmission unit.

21. The actuator as recited in claim 20, wherein the alignment element and the mating element are complementary to one another.

22. The actuator as recited in claim 21, wherein the alignment element and the mating element are complementary in such a way that one of:
the alignment element is provided as plug-like and the mating element is provided as socket-like, the alignment element being at least partly accommodated in the mating element, and
the alignment element is provided as socket-like and the mating element is provided as plug-like, the mating element being accommodated in the alignment element.

23. The actuator as recited in claim 20, wherein:
a space is established by a parallel offset of the alignment element of the drive unit relative to a drive axle of the drive unit,
a separation between a drive element and a transmission element is capable of being established as a result of the established space and of the engagement of the alignment element with the mating element of the transmission pin, and
the transmission element is situated on the transmission pin and is driveable with the aid of the drive element.

24. The actuator as recited in claim 20, wherein:
the mating element is engaged with the alignment element in an area between the drive unit and the transmission unit, and
the area is sealed with the aid of a sealing element in a media-tight manner.

25. The actuator as recited in claim 24, wherein the sealing element is situated around the mating element.

26. The actuator as recited in claim 25, wherein the sealing element is situated around the alignment element when the alignment element is engaged with the mating element.

27. The actuator as recited in claim 25, wherein the sealing element is situated between a housing wall of the drive unit and a housing wall of the transmission unit.

28. The actuator as recited in claim 27, wherein the mating element and the sealing element are covered by a cap.

29. The actuator as recited in claim 28, wherein:
the cap includes a step-like design including an annular surface and a circular surface,
the circular surface covers the mating element, and
the annular surface covers at least partly the sealing element.

30. The actuator as recited in claim 26, wherein the sealing element is situated between a housing wall of the transmission unit and one of a housing wall of the drive unit and a motor flange of the drive unit.
